(19) United States
(12) Patent Application Publication
(10) Pub. No.: US 2006/0174892 A1
(43) Pub. Date: Aug. 10, 2006

(54) Method and apparatus for magnetically connecting a head gear to an air mask

(76) Inventors: Steven Leksutin, Hillsboro, NH (US); Paul Chiesa, Candia, NH (US)

Correspondence Address: DEVINE, MILLIMET & BRANCH, P.A., 111 AMHERST STREET, BOX 719, MANCHESTER, NH, 03105, US

(21) Appl. No.: 11/325,708

(22) Filed: Jan. 5, 2006

Related U.S. Application Data
(60) Provisional application No. 60/641,635, filed on Jan. 5, 2005.

(51) Int. Cl. A62B 18/08; A62B 18/02

(52) U.S. Cl. 128/207.11; 128/207.13; 128/206.27; 128/207.18; 128/207.17

(57) ABSTRACT

A system for connecting a headgear to an air mask is provided. An end piece has a magnet molded into a cylindrical protuberance on the bottom of the end piece and is connected to a retention strap on the headgear. A receiving piece on the air mask has an indentation in it with a magnet contained in it at or near the indentation. When the protuberance on the end piece is placed in the indentation in the receiving piece, the magnets releasably connect the end piece and the receiving piece.

### CROSS-REFERENCE TO RELATED APPLICATIONS

The present application claims the benefit of Provisional Application Ser. No. 60/641,635 filed Jan. 5, 2005, which is incorporated herein by reference.

### FIELD OF THE INVENTION

The present invention relates to air masks for the delivery to a patent of pressurized air or therapeutic gas. Specifically, the present invention relates to a method and apparatus for magnetically connecting a head gear to an air mask to hold the air mask in place.

### BACKGROUND OF THE INVENTION

Patients suffering from a variety of medical conditions often require supplementary respiratory support, which can include the delivery of pressurized air or therapeutic gas. One style of delivery apparatus is a mask, designed to conform to a patient's particular body structure, that provides the air or other gas. The mask may cover only the nasal area of a patient or a larger area of a patient's face including the patient's mouth. Such a nasal mask is described in U.S. Pat. No. 6,631,718, incorporated herein in its entirety by reference. Hereinafter “mask” shall include both a nasal mask and a mask designed to cover a larger area of a patient's face.

Typically, such a mask is held in place by a headgear. For example, in FIG. 1 headgear 2 holds mask 1 in place. Retention straps 3, 4 (only the retention straps on one side of the headgear 2 being shown) connect the headgear 2 to the mask 1. In use, a patient passes each of the retention straps 3, 4 through respective slots 5, 6 on the mask. A hook and loop fastener system can be used to maintain the retention straps 3, 4 at a desired adjustment. The loops may be located along the majority of the lengths of the retention straps 3, 4 to provide a wide range of adjustment, with the hooks being located on the distal tip portions 7, 8 of the retention straps 3, 4, respectively, such that when the distal tip of a strap is passed through a slot, the retention strap folds over on itself and the hooks engage the loops.

Alternatively, the correct length of a retention strap can be adjusted and a snap on the distal tip can engage with a mating button along the retention strap. Thus, a patient only has to adjust a retention strap once, rather than adjusting the retention strap each time he dons the mask. However, even with this improvement, the distal tips of the retention straps must be passed through the respective slots on the mask each time the mask is used.

It is an object of the present invention to provide a method and apparatus connecting a head gear to a mask so that the retention straps need only be adjusted or threaded through slots the first time the mask is used. It is a further object of the present invention to provide a means of connecting a head gear to a mask such that they are easily and smoothly connected and released. It is a further object of the present invention to provide a means of connecting a head gear to a mask that is not degraded by repeated connections and releases.

### SUMMARY OF THE INVENTION

The present invention is a method and apparatus for magnetically connecting a headgear to an air mask. It comprises an end piece and a receiving piece. The end piece is connected to a retention strap on the headgear when a patient passes the retention strap through a slot in the end piece. As described above, a hook and loop fastener system can be used to maintain the strap at a desired length so that a patient only has to adjust a strap once rather than adjusting it every time he uses the mask. The receiving piece can be built into or added onto the mask.

The end piece is removably held in place against the receiving piece by magnets in the end piece and receiving piece.

### BRIEF DESCRIPTION OF THE DRAWINGS

These and other features and advantages of the present invention will be better understood by reading the following detailed description, taken together with the drawings wherein:

FIG. 1 is a diagram of a headgear and air mask being held in place on a patient by retention straps according to the prior art.

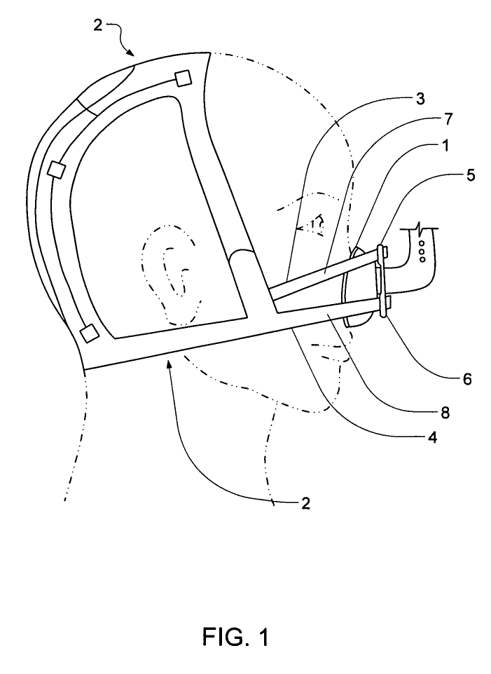

FIG. 2 is a top view of an end piece of one embodiment of the present invention.

FIG. 3 is a top view of a receiving piece of one embodiment of the present invention.

FIG. 4 is a side view of the end piece of FIG. 2 and the receiving piece of FIG. 3.

FIG. 5 is a top view of an end piece of another embodiment of the present invention.

FIG. 6 is a top view of a receiving piece of another embodiment of the present invention.

FIG. 7 is a side view of the end piece of FIG. 5 and the receiving piece of FIG. 6.

FIG. 8 is a perspective view of an end piece and receiving piece of another embodiment of the present invention.

FIG. 9 is a cut-away view of the end piece and receiving piece of FIG. 8 unconnected.

FIG. 10 is a cut-away view of the end piece and receiving piece of FIG. 8 connected.

FIG. 11 is a side view of an unconnected end piece and receiving piece of another embodiment of the present invention.

FIG. 12 is a side view of the end piece and the receiving piece of FIG. 11 connected.

### DETAILED DESCRIPTION OF THE INVENTION

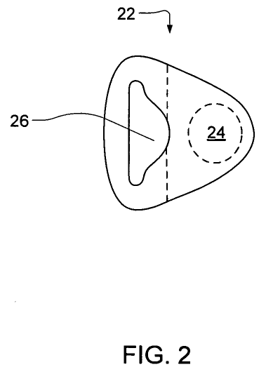

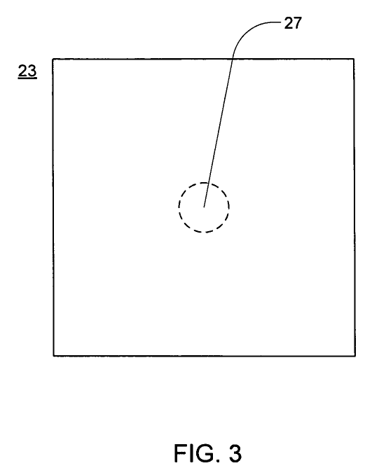

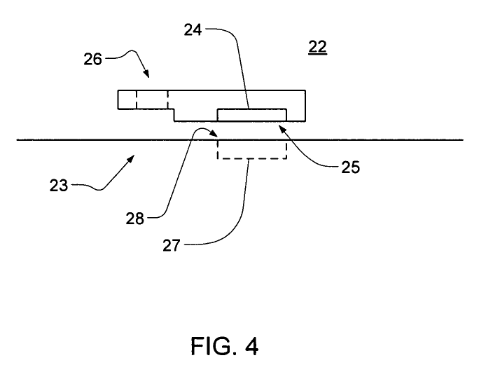

The present invention is a method and apparatus for magnetically connecting a headgear to an air mask to hold it in place on a patient. In one embodiment, as shown in FIGS. 2-4, it comprises an end piece 22 and a receiving piece 23. The end piece 22 has a magnet 24 within it flush with the bottom 25 of the end piece 22. The term “magnet” is used herein to mean both an electromagnet and a permanent magnet, such as rare-earth, samarium cobalt, ceramic, plastic and alnico magnets, as well as other types known to those skilled in the art. The end piece 22 is connected to the headgear when a user passes a retention strap connected to the headgear through a slot 26 in the end piece 22. As described above, a hook and loop fastener system can be used to maintain the retention strap at a desired length so that a patient only has to adjust the strap once rather than adjusting it every time he uses the mask. Other means known to those skilled in the art can also be used to connect an end piece to a retention strap.

The receiving piece 23 has a magnet 27 in it flush with the top 28 of the receiving piece 23. The receiving piece 23 can be built into or added onto the air mask.

When placed in proximity, the magnet 24 in the end piece 22 and the magnet 27 in the receiving piece 23 are releasably connected to each other and reliably secure the end piece 22 to the receiving piece 23.

It is to be understood that a reference to “magnets” in the end piece and receiving piece in this and other embodiments includes both a reference to a magnet in each of the end piece and the receiving piece and a reference to a magnet in one of the said pieces and to a “ferromagnetic material” in the other of the said pieces, which term is used herein to mean a material that is not magnetized itself but is attracted to a magnet. It is also to be understood that the orientation of the end piece and receiving piece in this and other embodiments may be reversed so that the receiving piece is part of the headgear and end piece is connected to a retention strap on the mask.

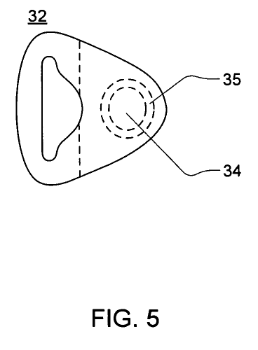

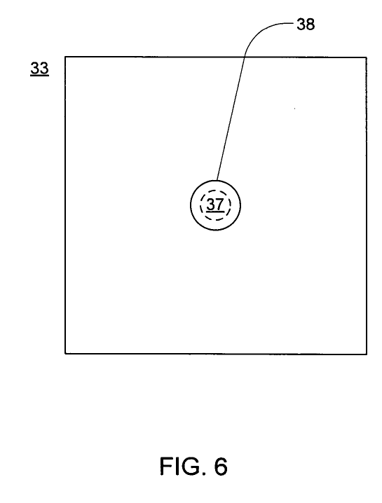

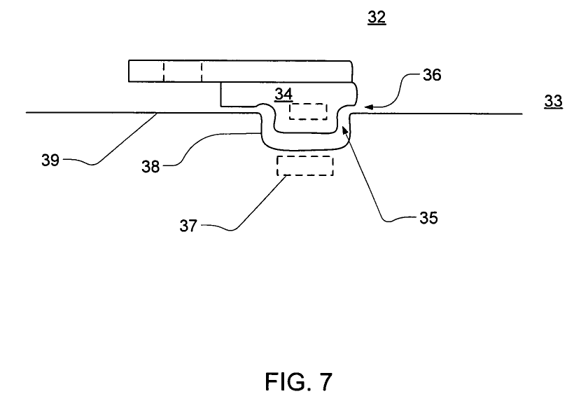

In another embodiment of the present invention, as shown in FIGS. 5-7, features are added to counteract the shearing force exerted on the connection of the end piece and the receiving piece by the retention strap. It comprises an end piece 32 and a receiving piece 33. The end piece 32 has a magnet 34 molded into a cylindrical protuberance 35 on the bottom 36 of the end piece 32. The end piece 32 is connected to a retention strap in the same way as described above.

The receiving piece 33 has a magnet 37 molded in it at the bottom of a cylindrical indentation 38 in the top 39 of the receiving piece 33, which can again be built into or added onto the air mask. It is to be understood that the size and shape of the protuberance 35 and the indentation 38 which are both cylindrical in this embodiment may be varied and hence not match so long as they mate for a reliably secure connection.

When the protuberance 35 on the end piece 32 is placed in the indentation 38 in the receiving piece 33, the magnet 34 in the end piece 32 and the magnet 37 in the receiving piece are releasably connected to each other and reliably secure the end piece 32 to the receiving piece 33. It is to be understood that the magnets 34 and 37 can be different sizes and strengths depending on the strength of the connection desired.

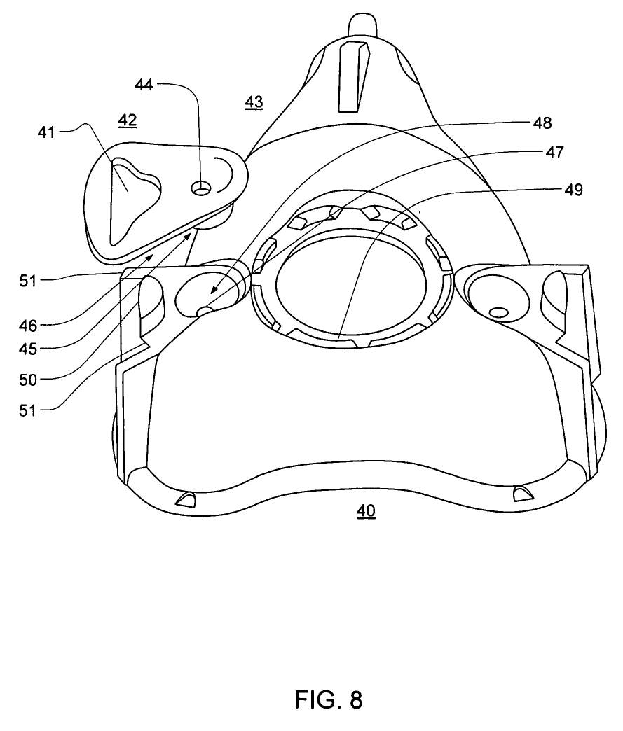

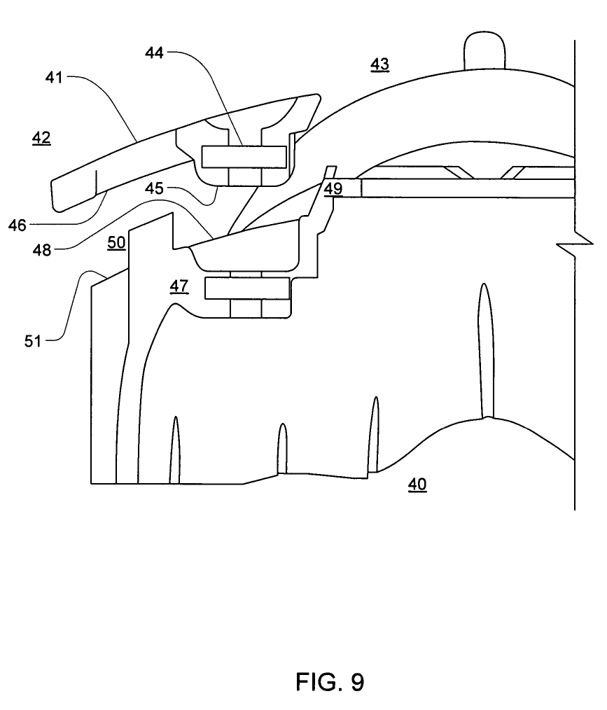

Yet another embodiment of the present invention is shown in FIGS. 8-10. It comprises an end piece 42 and a receiving piece 43, here shown as part of an air mask 40. The end piece 42 is made of acrylonitrile butadiene styrene (“ABS”) and has a magnet 44 insert molded into a cylindrical protuberance 45 on the bottom 46 of the end piece 42. In this embodiment, the magnet 44 is a commercially available nickel-plated neodymium disc magnet with a diameter of 0.375 inches and a thickness of 0.10 inches. The end piece 42 is connected to a retention strap in the same way as described above through the use of a slot 41 in the end piece 42.

The receiving piece 43, which is part of the polyvinyl chloride (“PVC”) mask 40, has a magnet 47 insert molded in it at the bottom of a cylindrical indentation 48 in the top 49 of the receiving piece 43. The magnet 47 is also a commercially available nickel-plated neodymium disc magnet with a diameter of 0.375 inches and a thickness of 0.10 inches.

The receiving piece 43 also has a projection 50 extending outward from the top 49 of the receiving piece 43 and two ridges 51 on the top 49 of the receiving piece 43. When the protuberance 45 on the end piece 42 is placed in the indentation 48 in the receiving piece 43, the magnet 44 in the end piece 42 and the magnet 47 in the receiving piece 43 are releasably connected to each other and reliably secure the end piece 42 to the receiving piece 43.

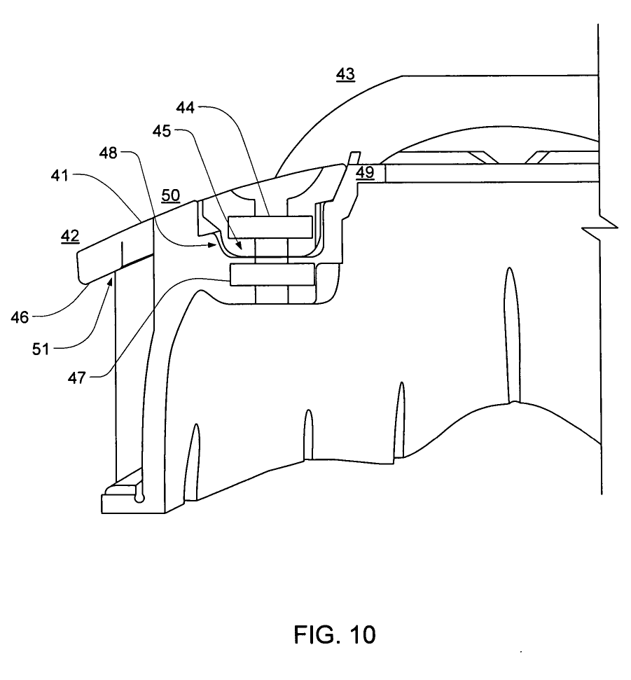

In addition, when the end piece 42 is so secured to the receiving piece 43, as shown in FIG. 10, the projection 50 on the receiving piece 43 extends through the slot 41 on the end piece 42 thereby further countering the shearing force exerted on the connection of the end piece and the receiving piece by the retention strap attached through slot 41 of end piece 42. Also, the end piece 42 sits on the ridges 51 in the receiving piece 43. The normal force between the end piece 42 and the ridges 51 counters any rotational forces acting to turn the end piece 42 about the axis of cylindrical protuberance 45.

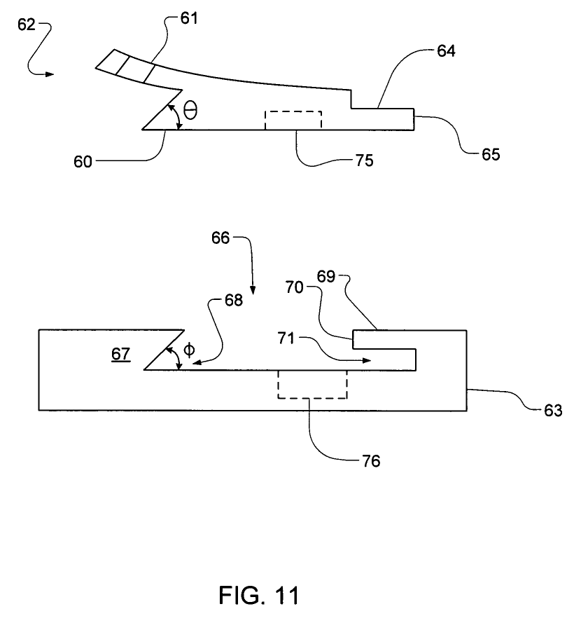

In still another embodiment of the present invention, as shown in FIG. 11, the end piece 62 has two sides. The first side 60 is adjacent to the slot 61 and has a slanted wall that makes an angle θ with the bottom of the end piece 62 that is 90° or less. The opposite side 64 of the end piece 62 has an extension 65 that is thinner than the body of the end piece. The receiving piece 63 has an indentation 66 in it that has two sides. The first side 67 has a slanted wall that makes the angle Φ, which is greater than θ but less than 90°, with the bottom of the indentation thereby creating cavity 68 into which the first side 60 of the end piece can fit. The opposite side 69 of indentation 66 has a lip 70 creating a cavity 71 into which the extension 65 of the end piece 62 can fit. Magnets 75, 76 are located in the end piece 62 and in the bottom of the indentation 66 in the receiving piece 63, respectively.

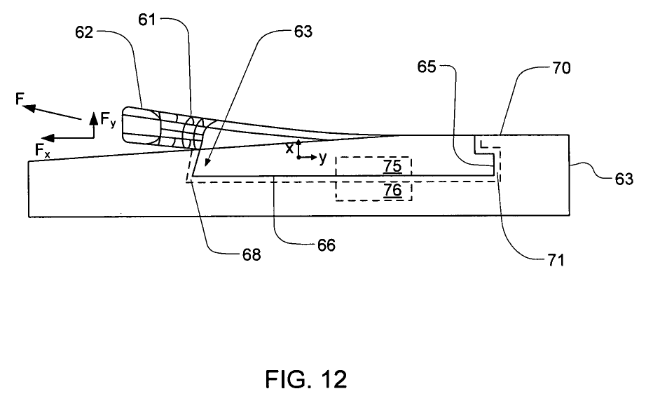

In use, as shown in FIG. 12, the end piece 62 is placed into the indentation 66 in the receiving piece 63 by first inserting the extension 65 of the end piece 62 into cavity 66 in the receiving piece 63. The first side 68 of the end piece 62 is then placed into the indentation 66. The force exerted by the retention strap in slot 61 of the end piece 62 moves the first side 60 of the end piece 62 into the cavity 68. The end piece 60 is held in the indentation 66 by the attraction of the magnets 75, 76.

As shown in FIG. 12, the force F exerted by the retention strap on the end piece 62 can be resolved into components Fx in the X direction and Fy in the Y direction. The larger force in the X direction acts to keep the first side 60 of the end piece 62 in the cavity 68 in the receiving piece 63. The force Fy in the Y direction is resisted by the attractive force of the magnets 75, 76. It is also resisted by the lip 70 creating the cavity 71 in the receiving piece 63, under which the extension 65 on the end piece 62 slides, and by the slanted wall creating the cavity 68, into which the first side 60 of the end piece 62 fits.

The invention claimed is:

1. An apparatus for magnetically connecting a headgear to an air mask comprising:
an end piece containing a magnet, and
a receiving piece containing a magnet.

2. The apparatus of claim 1 further comprising a slot in the end piece through which a retention strap on the headgear is threaded to connect the end piece to the headgear, and wherein the receiving piece is a part of the mask.

3. The apparatus of claim 1, wherein the magnet contained in the end piece or the magnet contained in the receiving piece is replaced by a ferromagnetic material.

4. An apparatus for magnetically connecting a headgear to an air mask comprising:
an end piece with a protuberance containing a magnet;
a receiving piece with an indentation into which the protuberance on the end piece fits; and
a magnet contained in the receiving piece at or near the indentation.

5. The apparatus of claim 4 wherein the protuberance and the indentation are each cylindrical in shape.

6. The apparatus of claim 4 further comprising one or more ridges on the receiving piece such that a normal force between the end piece and the one or more ridges counteracts any rotational forces acting on the end piece.

7. The apparatus of claim 4 further comprising a slot in the end piece through which a retention strap on the headgear is threaded to connect the end piece to the headgear and wherein the receiving piece is a part of the mask.

8. The apparatus of claim 4 wherein the magnet contained in the end piece or the magnet contained in the receiving piece is replaced by a ferromagnetic material.

9. An apparatus for magnetically connecting a headgear to an air mask comprising:
an end piece with a slot and a protuberance containing a magnet;
a receiving piece with a projection and an indentation into which the protuberance on the end piece fits; and
a magnet contained in the receiving piece at or near the indentation such that when the protuberance on the end piece is placed in the indentation in the receiving piece, the projection on the receiving piece fits into the slot on the end piece.

10. The apparatus of claim 9 wherein the protuberance and the indentation are cylindrical in shape.

11. The apparatus of claim 9 further comprising one or more ridges on the receiving piece such that a normal force between the end piece and the one or more ridges counteracts any rotational forces acting on the end piece.

12. The apparatus of claim 9 further comprising a means for connecting the end piece to a retention strap on the headgear and wherein the receiving piece is a part of the mask.

13. The apparatus of claim 4 wherein the magnet contained in the end piece or the magnet contained in the receiving piece is replaced by a ferromagnetic material.

14. A method of magnetically connecting a headgear to an air mask comprising:
connecting an end piece containing a magnet to a retention strap on the headgear;
connecting a receiving piece containing a magnet to the air mask; and
releasably connecting the magnet in the end piece and the magnet in the receiving piece to secure the headgear to the air mask.

15. A method of magnetically connecting a headgear to an air mask comprising:
connecting an end piece containing a magnet to a retention strap on the mask;
connecting a receiving piece containing a magnet to the headgear; and
releasably connecting the magnet in the end piece to the magnet in the receiving piece to secure the headgear to the air mask.
